(19) United States
(12) Patent Application Publication
(10) Pub. No.: US 2010/0024533 A1
(43) Pub. Date: Feb. 4, 2010

(54) SENSOR

(75) Inventors: Mutsumi Kimura, Nagano (JP); Ye Liu, Nagano (JP); Toshihiro Hirai, Ueda-shi (JP); Midori Takasaki, Nagano (JP); Takashi Mihara, Tokyo (JP)

Correspondence Address: PEARNE & GORDON LLP, 1801 EAST 9TH STREET, SUITE 1200, CLEVELAND, OH, 44114-3108, US

(73) Assignees: SHINSHU UNIVERSITY, Nagano (JP); OLYMPUS CORPORATION, Tokyo (JP)

(21) Appl. No.: 12/564,304

(22) Filed: Sep. 22, 2009

Related U.S. Application Data
(63) Continuation of application No. PCT/JP2008/053902, filed on Mar. 5, 2008.

(30) Foreign Application Priority Data
Mar. 22, 2007 (JP) 2007-074967
Sep. 4, 2007 (JP) 2007-229188

(51) Int. Cl. G01N 5/02

(52) U.S. Cl. 73/73

(57) ABSTRACT

It is an object of the present invention to provide a sensor that can detect various types of volatile organic compounds (VOCs), such as acetone, propylene, and alcohols, an environmental contaminant, odor, and the like. The present invention is a sensor comprising a sensor element having at least two types or more of polymer films adsorbing a target substance, measurement means that measures the adsorption properties of the target substance adsorbed on the polymer films, and recognition means that performs multivariate analysis on the measured adsorption properties to recognize the target substance.

### TECHNICAL FIELD

The present invention relates to a sensor that detects a volatile organic compound and the like.

### BACKGROUND ART

In early diagnosis and prevention based on human breath in the medical field, it is indicated that various volatile organic compounds (hereinafter described as VOCs) contained in breath, such as acetone, propylene, and alcohols, are mixed, and that these are also different depending on physical condition and the state of exercise. Therefore, a sensor that selectively adsorbs various types of VOCs has been required.

Conventionally, a MOS (Metal Oxide Semiconductor) type sensor using a metal oxide semiconductor has generally been used as a chemical sensor.

The MOS type sensor is a sensor having a relatively small particulate crystal or sintered body of a metal oxide semiconductor as a base, is usually a ceramic structure having an electrode wire of Pt or the like inside, and is used at a high temperature of about 300° C. By catalytic reaction on the metal oxide surface at high temperature, gas molecules of alcohol and the like are reduced on the surface, taken in the electron-depleted metal oxide, and neutralized. Thus, the principle that the potential barrier of the grain boundary decreases to decreases resistance is used.

When the MOS type sensor is used as an odor recognition apparatus, it is difficult to directly measure molecular weight and mass as in gas chromatography and to specify the constituent molecules of a material as in an element analysis apparatus. This is because in the MOS type sensor practically used as a gas sensor, using the reduction of a gas by catalytic reaction on the surface of metal oxide at high temperature, a change in the conductivity of semiconductor is used, as described above, so that selectivity for a gas type is very low. Therefore, there has been a problem that the MOS type sensor has selectivity for the adsorption of a polar gas, such as alcohol, and an irritant gas, such as ammonia, but it has low sensitivity to a common VOC, such as alkane. So far, an odor sensor system using a plurality of MOS type sensors has been unsuitable for the detection of a wide range of VOCs.

In recent years, as a sensor replacing the MOS type sensor, a sensor system in which a sensitive film is formed on a surface of a frequency detection type mass sensor, such as a quartz resonator, or a piezoelectric element, such as a surface acoustic wave element, and the mass change of the sensitive film due to a substance adsorbed on this sensitive film is taken out as frequency change has gained attention. Also, recently, it has been alleged that a frequency detection type mass sensor fabricated with a very small size, using a technique called MEMS (Micro Electrical Mechanical System) in which fabrication is performed on a material, such as silicon, using a semiconductor processing technique, is excellent in terms of sensitivity, mass production, and integration.

For example, Patent Document 1 describes providing a sensor in which a sensitive film composed of a rubber-based material having a double bond, such as 1,2 polybutadiene, is formed on both surfaces or one surface of a piezoelectric vibrator, detecting oscillation frequency, phase property, amplitude property, and time response property obtained from the sensor, and identifying a substance adsorbed on the sensitive film from the detected values, using a statistical analysis method or a neural network method. However, Patent Document 1 only discloses that a sensitive film having different adsorption properties can be formed by using only 1,2 polybutadiene as a base material forming the sensitive film, and reacting bromine, iodine, or the like as a functional group, and there is no specific disclosure of a statistical method or a neural network method.

### Patent Document 1: Japanese Patent Laid-Open No. 11-10881

### Means for Solving the Problems

The present inventors have noted the relation between the combinations of various types of polymer films and various types of gases and adsorption properties, and studied diligently to find that there is a difference in adsorption properties to VOC types for each polymer film, and that the difference in adsorption properties is each characteristic depending on the combination of the polymer film and the VOC. Based on this finding, the present inventors have found that a sensor that can recognize a VOC is obtained by simultaneously adsorbing the same VOC on a plurality of polymer films, obtaining adsorption properties for each polymer film, and performing multivariate analysis.

The present invention is a sensor comprising a sensor element having at least two types or more of polymer films adsorbing a target substance, measurement means that measures the adsorption properties of the target substance adsorbed on the polymer films, and recognition means that performs multivariate analysis on the measured adsorption properties to recognize the target substance.

In the present invention, the adsorption property is preferably at least one or more selected from frequency change, a K-factor, adsorption response property, and desorption property. Also, the adsorption property is preferably calculated from vibration frequency change measured using a frequency detection type mass sensor.

Also, in the present invention, the multivariate analysis is preferably principal component analysis.

Further, in the present invention, the polymer films are preferably two or more selected from polybutadiene, polyisoprene, polystyrene, polyacrylonitrile, polycaprolactan, and a copolymer, and the copolymer is preferably a copolymer containing two types or more of acrylonitrile, butadiene, styrene, and methyl acrylate, as monomer units. The polymer films may be two types or more combining different copolymers. As the copolymer containing two types or more of acrylonitrile, butadiene, styrene, and methyl acrylate, as monomer units, a copolymer containing acrylonitrile and butadiene as monomer units, a copolymer containing styrene and butadiene as monomer units, a copolymer containing acrylonitrile, butadiene, and styrene as monomer units, and a copolymer containing butadiene, methyl acrylate, and acrylonitrile as monomer units are preferably used.

In the present invention, the recognition means is preferably one that previously measures the adsorption properties of a particular organic compound for the polymer films and performs multivariate analysis on the previously measured adsorption properties and the adsorption properties of the target substance to recognize the target substance.

Also, in the present invention, it is preferred to comprise concentration means that previously concentrates a gas to be measured, which contains the target substance, and introduces the concentrated gas into the sensor element.

Further, in the present invention, measurement means that measures the concentration of the target substance in the gas is preferred.

### BRIEF DESCRIPTION OF THE DRAWINGS

FIG. 1 is a diagram for explaining this embodiment;

FIG. 2 is a schematic view of a sensor element;

FIGS. 3A, 3B and 3C are diagrams showing one example of a desorption pattern;

FIG. 4 is a graph representing the relationship between δv and δh;

FIG. 5 is a graph representing the relationship among δv and δh and the K-factor for polystyrene and VOCs;

FIG. 6 is a graph representing the relationship among δv and δh and the K-factor for polybutadiene and VOCs;

FIG. 7 is a diagram showing the K-factor of 10 types of VOCs for four types of polymer films;

FIG. 8 is a diagram showing the adsorption response characteristic τ of nine types of VOCs for the four types of polymer films;

FIG. 9 is a diagram showing the correlation between the first principal component and the second principal component of principal component analysis using the K-factor;

FIG. 10 is a diagram showing the correlation between the second principal component and the third principal component of the principal component analysis using the K-factor;

FIG. 11 is a diagram showing the correlation between the first principal component and the third principal component of the principal component analysis using the K-factor;

FIG. 12 is a diagram showing the correlation between the first principal component and the second principal component of principal component analysis using the adsorption response characteristic τ;

FIG. 13 is a diagram showing the correlation between the second principal component and the third principal component of the principal component analysis using the adsorption response characteristic τ;

FIG. 14 is a diagram showing the correlation between the first principal component and the second principal component of principal component analysis using the K-factor and the adsorption response characteristic τ;

FIG. 15 is a diagram showing the correlation between the second principal component and the third principal component of the principal component analysis using the K-factor and the adsorption response characteristic τ;

FIG. 16 is a diagram showing the K-factor of 19 types of VOCs for five types of polymer films;

FIG. 17 is a diagram showing the correlation between the first principal component and the second principal component of principal component analysis using the K-factor; and

FIG. 18 is a diagram showing the correlation between the first principal component and the second principal component of principal component analysis using frequency change.

### DESCRIPTION OF SYMBOLS

10 . . . sensor element, 11 . . . substrate, 12 . . . measurement part, 13 . . . recognition part, S1 to S4 . . . polymer film

### BEST MODE FOR CARRYING OUT THE INVENTION

This invention will be described in detail below, based on an embodiment shown in the accompanying drawings.

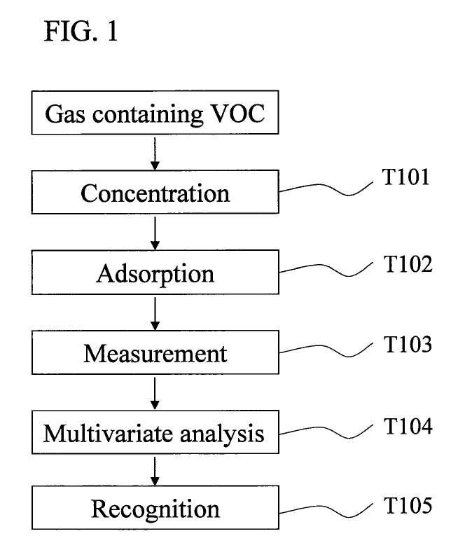

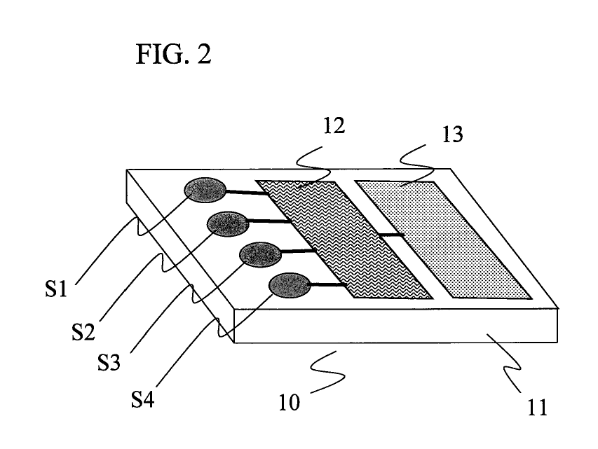

FIG. 1 is a diagram for explaining this embodiment, and FIG. 2 is a schematic view of a sensor element according to the present invention.

As shown in FIG. 1, in the sensor of the present invention, a gas containing a target substance, such as a VOC, is concentrated (T101) and then adsorbed by the sensor element (T102), the adsorption properties of the adsorbed substance are measured (T103), multivariate analysis is performed on the obtained measurement result (T104), and the target substance is recognized from the result of the multivariate analysis (T105).

As shown in FIG. 2, in a sensor element 10, polymer films S1, S2, S3, and S4 are formed on a substrate 11 and connected to a recognition part 13 via a measurement part 12. The process of T103 is performed in the measurement part 12, and the processes of T104 and T105 are performed in the recognition part 13.

T101 to T105 will be described in turn.

In T101, a gas to be measured, containing a target substance, is concentrated. This is preferably performed to increase sensitivity when the concentration of the target substance in the gas to be measured is low, but this need not necessarily be performed.

Concentration can be performed by a pump, a compressor, or the like.

In the present invention, regardless of the presence or absence of concentration means, all target substances contained in the gas to be measured are to be adsorbed by the polymer films. The target substances can be recognized without previously selecting a particular VOC, so that selectivity for various VOCs widens.

Also, in the present invention, the target substance is often a volatile organic compound (VOC), but carbon monoxide, carbon dioxide, hydrogen, an environmental contaminant, such as NOx and SOx, a volatile substance, an agricultural chemical, a food additive, a perfume, and offensive odor can also be recognized.

In T102, the target substance is adsorbed by the polymer films of the sensor element.

A schematic view of the sensor element 10 is shown in FIG. 2. As shown in FIG. 2, in the sensor element 10, four types of the polymer films S1, S2, S3, and S4 are formed on the substrate 11 and connected to detection means (not shown) that detects a physical change in the sensor element 10 when the target substance is adsorbed on the polymer films S1 to S4 on the sensor element 10. The polymer films S1 to S4 may be formed with any film thickness by spin coating, ink jetting, or the like. As the substrate 11 of the sensor element 10, a substrate in which a thin film of gold (Au) is formed on a surface of a silicon-based material is preferably used.

In FIG. 2, the sensor element 10 having four types of the polymer films S1 to S4 is described, but in the present invention, the sensor element may have only two types or more of polymer films. When a particular VOC is detected, detection is sufficiently possible by combining two types of polymer films having sensitivity to the VOC. For application to a sensor in which high sensitivity is required, and a sensor in which selectivity for many VOC types is required, the types of polymer films may be increased, and five types or more, and further 10 types or more of polymer films may be formed on the sensor element.

The present inventors have found that in selecting polymer films according to a VOC to be detected, a solubility parameter is useful as an indicator representing the properties of the VOC.

The definition of the solubility parameter will be described later. The solubility parameter comprises three indicators, a polar component δp, a dispersion component δd, and a hydrogen bonding component δh. By roughly classifying a VOC by any of these three indicators, and using polymer materials having high sensitivity in the unit of the indicator, various VOCs can be recognized in a wide range. In the present invention, by combining two types or more of polymer films having high sensitivity indicators different from each other, the precision of VOC recognition is improved, and the types of VOCs that can be recognized also increase.

When the properties of polymers and VOCs are classified by the three indicators of the solubility parameter, a polymer having sensitivity to the dispersion component δd has hydrophobicity and nonpolarity, a polymer having sensitivity to the polar component δp has polarity, and a polymer having sensitivity to the hydrogen bonding component δh has hydrophilicity. A hydrophilic VOC, such as alcohol, has low sensitivity to a hydrophobic polymer film, so that when the hydrophilic VOC is to be recognized, a polymer film having sensitivity to δp or δh is preferably used.

Among the materials of the polymer films, butadiene-based polymers, such as polybutadiene and polyisoprene, have high selectivity to the dispersion component δd, and high sensitivity (K-factor). Polystyrene has sensitivity to the polar component δp. Any of these polymers has sensitivity to a hydrophobic VOC, but they have different performance for responsivity representing gas diffusibility, and selectivity for selectively adsorbing a gas. Polystyrene is a glassy polymer having a hard polymer chain, so that a VOC gas does not diffuse easily (the time of reaction with the VOC gas is long), but diffusion depends on the size of the VOC molecule, and diffusion selectivity is high. Polybutadiene has a soft polymer chain, so that the gas diffuses easily (response time is early), but diffusion selectivity is low.

Also, polyacrylonitrile, a polymer in which butadiene is modified with a functional group, and a block copolymer of butadiene and a monomer in which butadiene is modified with a functional group have sensitivity to the polar component δp. As the monomer in which butadiene is modified with a functional group, acrylonitrile modified with a cyano group as a functional group, acrylate having an ester group, hydroxymethacrylate having a hydroxyl group, styrene having a benzene ring, vinyl ether having an ether group, and vinylamine having an amino group are preferred.

Polyvinylalcohol, polycaprolactan, and polymers having OH, NH₂, and SO₃H as functional groups have sensitivity to the hydrogen bonding component δh and have sensitivity to a hydrophilic VOC, such as alcohol.

For the copolymer, by changing the selection and ratio of monomers comprising the copolymer, a polymer material having the desired solubility parameter can be designed. In the present invention, a copolymer containing two types or more of acrylonitrile, butadiene, styrene, and methyl acrylate, as monomer units, is preferably used. Particularly, a copolymer containing acrylonitrile and butadiene as monomer units, a copolymer containing styrene and butadiene as monomer units, a copolymer containing acrylonitrile, butadiene, and styrene as monomer units, and a copolymer containing butadiene, methyl acrylate, and acrylonitrile as monomer units are preferably used.

For example, a copolymer containing acrylonitrile and butadiene as monomer units, represented by a general formula [Formula 1], has improved oil resistance, heat resistance, gas resistance, and responsivity, and also excellent stability, compared with polybutadiene, because the polar component δp is high due to the introduction of a cyano group. In [Formula 1], a is preferably in the range of 0.01 to 0.99, b is preferably in the range of 0.01 to 0.99, and a+b=1 is preferred.

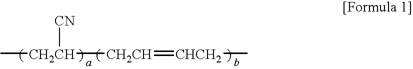

A block copolymer of polystyrene and polybutadiene represented by a general formula [Formula 2] is a copolymer in which butadiene that is a rubber-like polymer, and styrene that is a glassy polymer are combined. In [Formula 2], c is preferably in the range of 0.01 to 0.99, d is preferably in the range of 0.01 to 0.99, e is preferably in the range of 0.01 to 0.99, and c+d+e=1 is preferred.

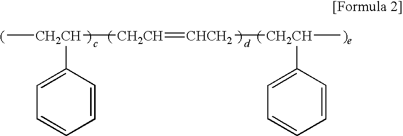

A copolymer of acrylonitrile, butadiene, and styrene, represented by a general formula [Formula 3], has excellent stability, compared with polystyrene and polybutadiene, because the polar component δp is high due to the introduction of a cyano group. In [Formula 3], f is preferably in the range of 0.01 to 0.99, g is preferably in the range of 0.01 to 0.99, h is preferably in the range of 0.01 to 0.99, and f+g+h=1 is preferred.

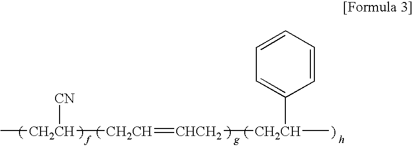

By combining polymers having different performance to make a copolymer having the desired performance, in this manner, the range of VOC selectivity is widened.

For the copolymer, an irregular copolymer, an alternating copolymer, and a graft copolymer can also be used, other than the block copolymer. For example, a polymer film obtained by graft polymerizing polybutadiene with a copolymer of methyl acrylate and acrylonitrile and represented by a general formula [Formula 4] has sensitivity to a hydrophilic VOC due to the action of methyl acrylate and acrylonitrile. In [Formula 4], i is preferably in the range of 0.01 to 0.99, j is preferably in the range of 0.01 to 0.99, k is preferably in the range of 0.01 to 0.99, and i+j+k=1 is preferred.

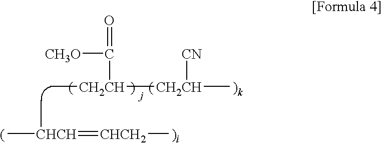

In the sensor of the present invention, the polymer films are selected according to the VOC, so that depending on the combination of the polymer films, various VOCs can be recognized in a wide range.

In T103, the adsorption properties of the substance adsorbed by the sensor element are measured.

In the present invention, the adsorption properties represent the characteristics of adsorption and desorption between the polymer film and the VOC type, and are preferably at least one or more selected from frequency change, a K-factor, adsorption response property, and desorption property. Particularly, by combining the K-factor that does not depend on the concentration of the VOC and the thickness of the polymer film, and the adsorption response property regarding time, recognition with good precision is possible.

The definition of the K-factor and the adsorption response property will be described later. If a physical change in the sensor element when the target substance is adsorbed on the sensor element is detected by the detection means, and a detected value obtained by the detection means is subjected to calculation process, based on the definition of the K-factor or the adsorption response time, the K-factor or the adsorption response property can be easily obtained.

As the detection means, methods of electrical detection, optical detection, chemical detection, electrochemical detection, and the like can be applied. As the detection means applied to the sensor of the present invention, a frequency detection type mass sensor, such as a quartz resonator, is preferably used. The frequency detection type mass sensor, such as a quartz resonator, detects mass change due to the adsorption and desorption of the target substance, as a change in frequency. Here, a most general quartz crystal microbalance (hereinafter described as QCM) that detects as the vibration frequency change of a quartz resonator is shown as an example. The QCM has high sensitivity in the detection of a trace component.

In the QCM, when a substance is adsorbed on a surface of the quartz resonator, the fundamental vibration frequency of the quartz resonator changes in proportion to the mass of the adsorbed substance according to the following Sauerbrey's formula (expression (1)). Here, ΔF is a change in fundamental vibration frequency, Δm is weight change, and a is a constant. In the QCM, a change in fundamental vibration frequency is changed to an electrical signal and measured as frequency change.

[Expression 1]

ΔF=−a×Δm (1)

The K-factor is represented by the proportion of the mass of the substance adsorbed on the polymer film to the mass of the gas to be measured. The K-factor is different depending on the combination of the polymer film and the VOC. When the same VOC is adsorbed on a plurality of polymer films, the K-factor shows a characteristic pattern for each polymer film. Also, for each VOC type, the characteristics of the pattern of the K-factor for the polymer film are different. The adsorption capacity is observed by frequency change, but the change in frequency also varies depending on (is generally proportional to) the concentration of the VOC in air, and the film thickness of the polymer film, in addition to the combination of the polymer film and the VOC. Therefore, in the present invention, using, as a parameter of multivariate analysis, the K-factor that does not depend on the concentration of the VOC in air, and the film thickness of the polymer film, and changes depending on the combination of the polymer film and the VOC, to analyze the characteristic pattern of the K-factor and recognize the VOC type, is mainly considered. Here, in measuring the adsorption properties, frequency change may be used as the adsorption properties, instead of the K-factor, when measurement is performed with the concentration of the VOC in air and the film thickness of the polymer film fixed (or fixed film thickness for each different polymer film).

The present inventors presumes that when the same VOC is adsorbed on a plurality of polymer films, the VOC shows a characteristic pattern of the K-factor for each polymer film because of depending on the solubility parameter. There is a tendency that with the combination of a polymer film and a VOC having a close solubility parameter value, the K-factor value increases, and with the combination of a polymer film and a VOC having a very different solubility parameter value, the K-factor value decreases.

The adsorption response property is time from the start of adsorption until a fixed amount is adsorbed. When the adsorption speed is fast, this time is short, and when the adsorption speed is slow, this time is long. When the same VOC is adsorbed on a plurality of polymer films, the pattern of the adsorption response property obtained for each polymer film can also be used as a parameter of multivariate analysis.

Also when the VOC desorbs from the polymer film after the polymer film adsorbs the VOC, the desorption pattern after adsorption greatly changes depending on the combination of the adsorbed VOC and the polymer film.

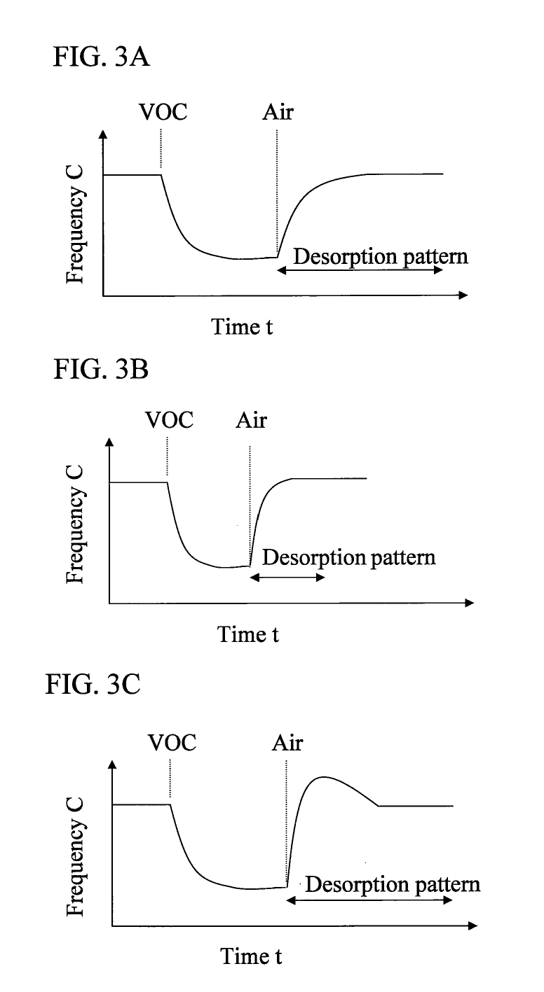

FIGS. 3A, 3B, and 3C are diagrams showing one example of a desorption pattern, and schematically show a change in a vibration frequency C with respect to a time t from when the VOC desorbs from the polymer film to when the vibration frequency returns to the vibration frequency before adsorption. In FIGS. 3A, 3B, and 3C, VOC represents the start of the adsorption of the “VOC” on the polymer film by the introduction of the VOC, and “Air” is a start point at which the VOC starts desorption from the polymer film by the introduction of air.

From FIGS. 3A and 3B, it is seen that the time after air is introduced until desorption is completed is different. Also, as shown in FIG. 3C, there is a desorption pattern in which the vibration frequency temporarily changes higher than the vibration frequency before adsorption. This shows a possibility that the VOC dissolves part of the polymer film and desorbs.

By considering the difference in desorption pattern as desorption property, such as desorption speed and desorption time, it can be used as a parameter of multivariate analysis.

In T104, by performing multivariate analysis on the adsorption properties, the target substance can be recognized (T105).

Here, description is given using principal component analysis that can be stably used with high reliability among multivariate analyses.

In principal component analysis, when a VOC having certain properties, for example, acetone, is detected by the plurality of polymer films S1, S2, S3, and S4 as shown in FIG. 2, and the adsorption property is measured, a linear vector obtained by multiplying the measurement result with a coefficient and adding the multiplied measurement result is considered, and the coefficient of the linear vector in which the variance is maximum is obtained to determine the axis of a principal component. Here, the variance being maximum is that the average of the linear vectors is obtained, and a coefficient in which the square sum of the difference between each vector and the average is maximum is found. Thus, a principal axis (first principal component axis) is obtained, and using a second principal component axis orthogonal to the principal axis, and a third principal component axis orthogonal to the second principal component axis, at what position the VOC is represented on a graph of the principal component analysis result is obtained, so that the recognition of the VOC is possible.

In the present invention, the recognition of the VOC is possible by previously measuring the adsorption properties of a particular organic compound for the polymer film, and performing principal component analysis on the previously measured adsorption properties and the adsorption properties of the target substance to obtain at what position the target substance is represented on a graph of the principal component analysis result.

By measuring the adsorption properties of the target substance, it is sometimes possible to narrow the target substance to some extent from the pattern of the adsorption properties when either one of the type of the VOC and the concentration of the VOC is determined. But, when both of the type of the VOC and the concentration of the VOC are estimated, it is difficult to recognize the unknown VOC only from the pattern of the adsorption properties. This is because, for example, when the patterns of the adsorption properties of two types of VOCs are similar, they cannot be discriminated. In such a case, by performing principal component analysis on adsorption properties obtained by previously measuring the adsorption properties of a particular organic compound, that is, known adsorption properties, and the adsorption properties of the target substance, the pattern of the adsorption properties is verified from various angles, so that the target substance can be recognized with good precision.

For the principal component analysis, the free software on the internet “PPCA1 (Yasuharu Okamoto, “Kokoro wo Hakaru (Mind Is Measured),” Principal Component Analysis, [online], [searched on Aug. 31, 2007], internet <URL:http://www.ikuta.jwu.ac.jp/˜yokamoto/openwww/pca/>), “the statistical software “Mikeneko,” and the like can be used.

“Mikeneko” is statistical software that is an appendix to “Excel de Kantan Tahenryokaiseki (Multivariate Analysis Easy with Excel,” Masahiro Ogura, (Kodansha Ltd., published in August, 2006).

Also, in the present invention, the mass of the entire target adsorbed on the polymer film is measured by the QCM or the like, so that the concentration of the entire target substance contained in the gas to be measured can be measured as a converted value, such as xylene conversion and toluene conversion.

Next, the definition of the K-factor and the adsorption response property, and the solubility parameter will be described.

### <K-Factor>

The K-factor is an index showing to what extent a gas or a molecule in air is dissolved in an adsorption material, such as a polymer, and is represented by the ratio of the weight concentration (weight per unit volume) of the molecule in the adsorbing polymer to the weight concentration (weight per unit volume) of the molecule in air, as shown in an expression (2). In the expression (2), C_{f} represents the molar concentration (mol/cm³) of the gas in the film, Cᵥ represents molar concentration (mol/cm³) in the chamber, M_{cf} represents the weight concentration (g/cm³) of the gas in the film, and M_{cv} represents the weight concentration (g/cm³) of the gas in the chamber.

$$\begin{matrix}[ Expression 2 ] & \\ K = \frac{{C}_{f}}{{C}_{v}} = \frac{{M}_{cf}}{{M}_{cv}} & ( 2 )\end{matrix}$$

Here, when f_{g} is frequency during gas adsorption, f_{f} is frequency during polymer film formation, f₀ is the frequency of the crystal before film formation, M₀ is the weight of the crystal, M_{ft} is the weight of the polymer thin film, A is the area of the gold surface of the crystal, t_{f} is the film thickness of the polymer film, and ρ_{f} is the density of the polymer film, the relationship of the following expression (3) holds between the frequency and the weight of each portion. Here, the ratio of f₀ to f_{f}, and the ratio of M₀ to M_{ft} are close to one, so that the following expression (4) holds. Then, as the relationship with the K-factor, an expression (5) is derived.

$$\begin{matrix}[ Expression 3 ] & \\ \frac{{f}_{g} - {f}_{f}}{{f}_{f} - {f}_{0}} = - \frac{{f}_{0}}{{f}_{f}} \frac{{M}_{0}}{{M}_{ft}} \frac{{At}_{f} {M}_{cf}}{{At}_{f} {ρ}_{f}} & ( 3 ) \\ [ Expression 4 ] & \\ \frac{{f}_{g} - {f}_{f}}{{f}_{f} - {f}_{0}} = - \frac{{M}_{cf}}{{ρ}_{f}} & ( 4 ) \\ [ Expression 5 ] & \\ K = \frac{{ρ}_{f}}{{M}_{cv}} \frac{{f}_{g} - {f}_{f}}{{f}_{f} - {f}_{0}} & ( 5 )\end{matrix}$$

Here, for the adsorption properties, when the gas concentration is sufficiently low, the adsorption amount is proportional to the concentration, and generally, the thickness of the film and the adsorption amount are proportional to each other, so that this K-factor is an amount that does not depend on the concentration, and the thickness of the polymer film.

When the expression (5) is transformed, an expression (6) is obtained.

$$\begin{matrix}[ Expression 6 ] & \\ {f}_{g} - {f}_{f} = K \frac{{M}_{cv}}{{ρ}_{f}} ( {f}_{f} - {f}_{0} ) & ( 6 )\end{matrix}$$

In the expression (6), frequency change due to gas adsorption can be obtained from the K-factor and the gas concentration.

It is presumed that this K-factor is proportional to surface area for nanofiber and a porous material, is determined by the number of inner adsorption trap sites for a hard polymer having relatively high density, and is determined by the amount of gas contained inside for a material with weak interaction between molecules, such as a rubber-based material.

### <Adsorption Response Property>

It is considered that when a polymer adsorbs a gas, adsorption is performed at very high speed for nanofiber and a porous material because of being adsorption on the surface, and adsorption is determined by gas diffusion into the trap sites for the hard polymer having relatively high density. Therefore, it is considered that the adsorption response property greatly changes depending on the properties of the adsorbed gas and the polymer, and the combination thereof.

When gas adsorption is such that an energy barrier consist of only single component is exceeded by thermal energy, or when gas adsorption is reactive adsorption considered as first-order reaction, the adsorption response property is represented by such an expression (7) having a single time constant. Here, C(t) is the time dependence of a measurement amount, Cs is a saturation measurement amount, C0 is a value at time 0, and τ is a time constant. When the expression (7) is transformed, the following expression (8) is obtained.

$$\begin{matrix}[ Expression 7 ] & \\ C ( t ) - Cs = ( Co - Cs ) Exp ( - \frac{t}{τ} ) & ( 7 ) \\ [ Expression 8 ] & \\ C ( t ) = Co Exp ( - \frac{t}{τ} ) - Cs ( 1 - Exp ( - \frac{t}{τ} ) ) & ( 8 )\end{matrix}$$

Further, when

t=∞→C(t)=Cs

t=0→C(t)=C0

t=τ→C(t)−Cs=0.367(C0−Cs)

are set as boundary conditions, the time constant τ is defined when C(t) reaches 36.7% of a saturation value. In other words, since the measurement amount is frequency for a mass detection oscillation type sensor, frequency before gas adsorption is C0, time from start is t, frequency at a point when a saturation value is reached is Cs, and the time of 63.7% of a difference between Cs and C0 is τ.

### <Solubility Parameter>

Indicators representing the properties of the VOC include the solubility parameter. This solubility parameter comprises three indicators, i.e., the polar component δp, the dispersion component δd, and the hydrogen bonding component δh.

In the present invention, the polar component δp and the dispersion component δd having similar effect are combined into δv by an expression (9).

[Expression 9]

δv=(δd2+δp2)1/2 (9)

By roughly classifying VOCs from the relationship between δv and δh, and using polymer materials having high sensitivity in the unit of this indicator, various VOCs can be recognized in a wide range.

The solubility parameters of 12 types of VOCs are shown in Table 1. The 12 types of VOCs are hexane, heptane, octane, o-xylene, p-xylene, toluene, benzene, chloroform, dichloromethane, 1,2-dichloroethane, 1-butanol, and ethanol. The solubility parameters of four types of polymers are shown in Table 2. The four types of polymers are polystyrene (described as PS in the table), polyisoprene (described as PIP in the table), polybutadiene (described as PBD in the table), and a copolymer having acrylonitrile and butadiene as monomer units (described as PAB in the table, and hereinafter also sometimes described as PAB). In Table 1, δo is a total solubility parameter, δd is a dispersion component, δp is a polar component, δh is a hydrogen bonding component, and δv is a value obtained by combining δp and δd by the expression (9).

PAB described in Table 2 is a copolymer containing 30% acrylonitrile.

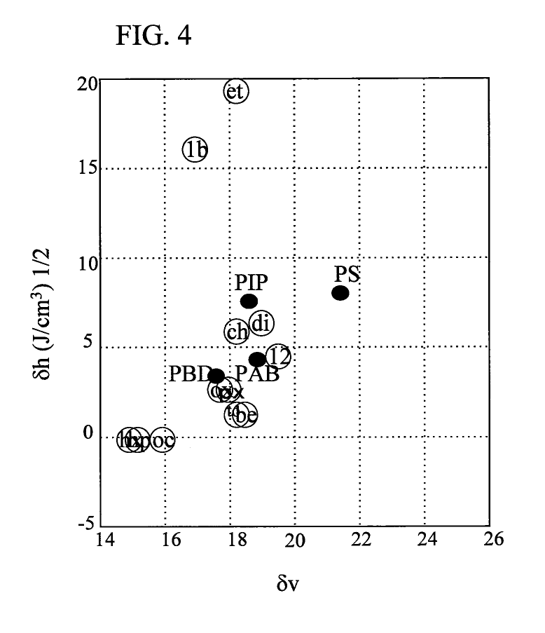

A graph based on Tables 1 and 2 and representing the relationship between δv and δh is shown in FIG. 4. In FIG. 4, hexane represents hx, heptane represents hp, octane represents oc, o-xylene represents ox, p-xylene represents px, toluene represents to, benzene represents be, chloroform represents ch, dichloromethane represents di, 1,2-dichloroethane represents 12, 1-butanol represents 1b, ethanol represents et, polystyrene represents PS, polyisoprene represents PIP, polybutadiene represents PBD, and the copolymer having acrylonitrile and butadiene as monomer units represents PAB.

Seeing FIG. 4, it is found that the distributions of polybutadiene (PBD), o-xylene (ox), p-xylene (px), toluene (to), and benzene (be) are close, and the distributions of PAB, chloroform (ch), dichloromethane (di), and 1,2-dichloroethane (12) are close.

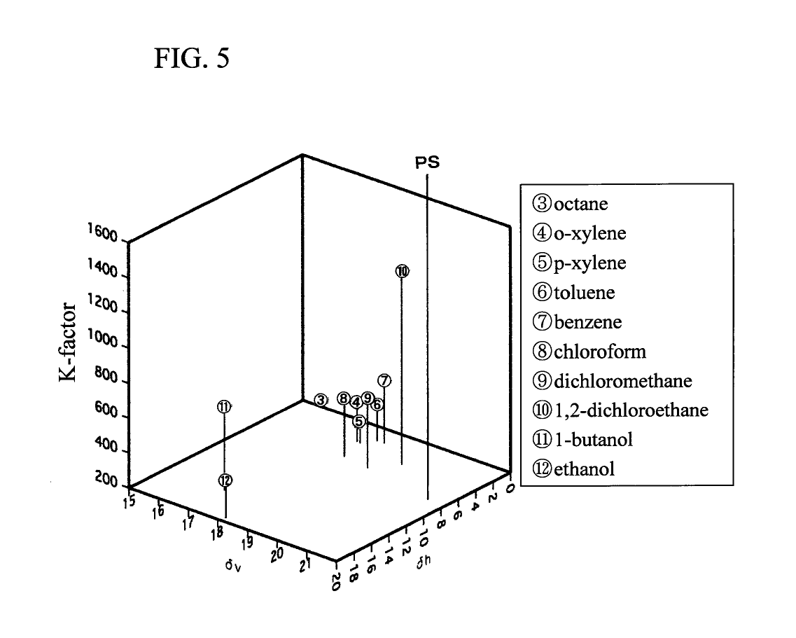

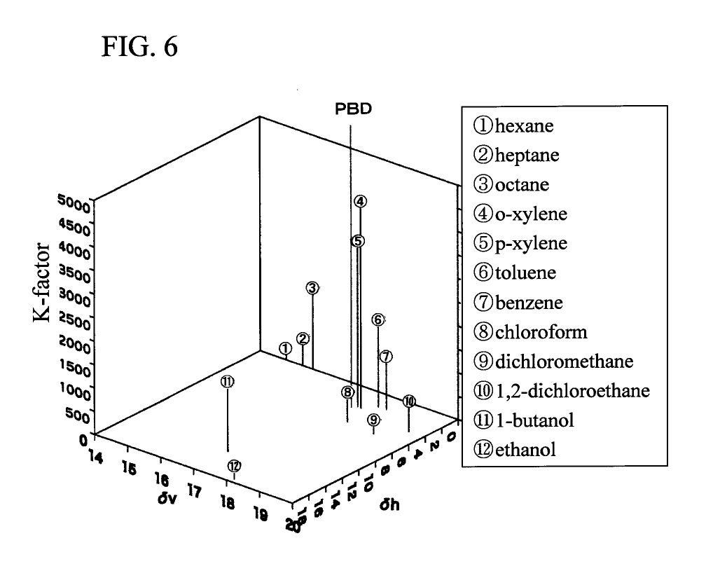

The relationship among δv and δh and the K-factor for polystyrene (PS) and each VOC is shown in FIG. 5. The relationship among δv and δh and the K-factor for polybutadiene (PBD) and each VOC is shown in FIG. 6. The K-factor is a value in Table 3 described in Example 1 described later. Seeing FIGS. 5 and 6, it can be confirmed that for most VOCs, the K-factor is higher as the VOC is positioned closer to the solubility parameter of polystyrene or polybutadiene, and the K-factor decreases as the VOC is away from polystyrene or polybutadiene. The present inventors consider that as the distributions of the solubility parameter δh and δv of the polymer material and the VOC are closer, the VOC is more easily adsorbed on the polymer material, and the K-factor is higher.

TABLE 1

| VOC | δo | δd | δp | δh | δv |
|---|---|---|---|---|---|
| hexane | 14.79 | 14.79 | 0 | 0 | 14.79 |
| heptane | 15.3 | 15.3 | 0 | 0 | 15.3 |
| octane | 15.6 | 15.6 | 0 | 0 | 15.6 |
| o-xylene | 18 | 17.8 | 1 | 3.1 | 17.82807 |
| p-xylene | 18 | 17.69 | 1.02 | 3.07 | 17.71938 |
| toluene | 18.26 | 18.04 | 1.43 | 2.05 | 18.09659 |
| benzene | 18.72 | 18.31 | 1.02 | 2.05 | 18.33839 |
| chloroform | 19 | 17.8 | 3.1 | 5.7 | 18.06793 |
| dichloromethane | 19.9 | 17.88 | 6.36 | 6.15 | 18.97746 |
| 1,2-dichloroethane | 20 | 18.8 | 5.3 | 4.1 | 19.53279 |
| 1-butanol | 23.1 | 16 | 5.7 | 15.8 | 16.98499 |
| ethanol | 26.43 | 15.81 | 8.8 | 19.43 | 18.09409 |

TABLE 2

| polymer material | δo | δd | δp | δh | δv |
|---|---|---|---|---|---|
| PS | 22.69 | 18.64 | 10.52 | 7.51 | 21.4037 |
| PIP | 19.8 | 18.4 | 2.1 | 7.2 | 18.5194 |
| PBD | 17.98 | 17.49 | 2.25 | 3.48 | 17.6341 |
| PAB | 20.18 | 17.7 | 6.44 | 4.48 | 18.8352 |

### Example 1

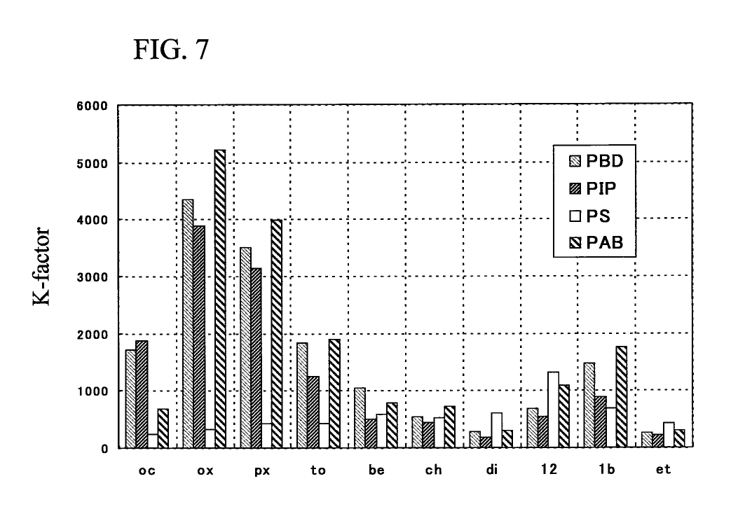

Four types of polymer films of polybutadiene (PBD), polyisoprene (PIP), polystyrene (PS), and a copolymer having acrylonitrile and butadiene as monomer units (PAB) were formed on the sensor element 10 shown in FIG. 2, and the K-factor for 10 types of VOCs was obtained. The results are shown in Table 3 and FIG. 7. The 10 types of VOCs are octane (oc), o-xylene (ox), p-xylene (px), toluene (to), benzene (be), chloroform (ch), dichloromethane (di), 1,2-dichloroethane (12), 1-butanol (1b), and ethanol (et).

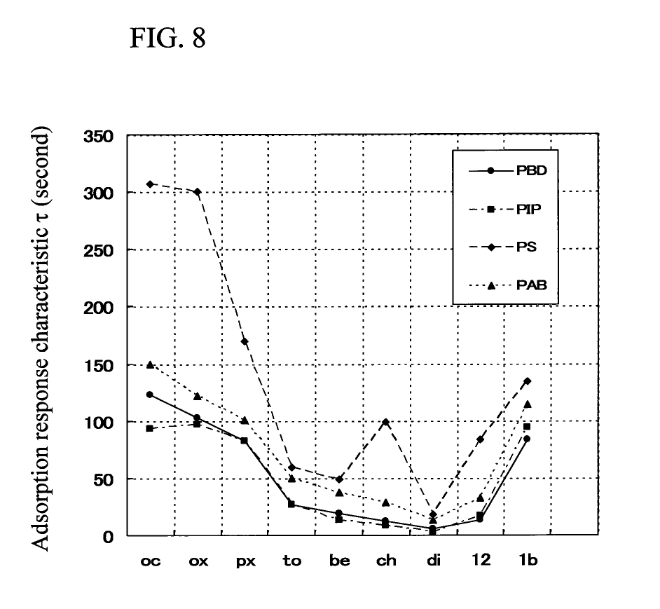

Also, the adsorption response characteristic τ of nine types of VOCs for the four types of polymer films was obtained. The results are shown in Table 4 and FIG. 8. The nine types of VOCs are the same as the VOCs for the K-factor, except for ethanol.

The K-factor and the adsorption response characteristic τ (second) was calculated from vibration frequency change obtained using a QCM.

TABLE 3

K-factor

| VOC | PBD | PIP | PS | PAB |
|---|---|---|---|---|
| octane | 1710 | 1876 | 240 | 676 |
| o-xylene | 4347 | 3895 | 330 | 5223 |
| p-xylene | 3507 | 3135 | 423 | 3981 |
| toluene | 1829 | 1256 | 419 | 1889 |
| benzene | 1052 | 507 | 576 | 793 |
| chloroform | 545 | 445 | 530 | 723 |
| dichloromethane | 285 | 176 | 599 | 308 |
| 1,2-dichloroethane | 676 | 535 | 1304 | 1096 |
| 1-butanol | 1471 | 881 | 679 | 1750 |
| ethanol | 269 | 225 | 418 | 309 |

TABLE 4

adsorption response
characteristic τ (second)

| VOC | PBD | PIP | PS | PAB |
|---|---|---|---|---|
| octane | 123 | 96 | 307 | 150 |
| o-xylene | 103 | 97 | 300 | 122 |
| p-xylene | 82 | 82 | 170 | 101 |
| toluene | 27 | 27 | 59 | 50 |
| benzene | 19 | 13 | 49 | 37 |
| chloroform | 12 | 9 | 99 | 29 |
| dichloromethane | 6 | 3 | 18 | 13 |
| 1,2-dichloroethane | 13 | 17 | 83 | 33 |
| 1-butanol | 83 | 94 | 134 | 114 |

The recognition of an unknown VOC only from the K-factor and the adsorption response property of a sensor using a single polymer material is very difficult. This is because when an unknown VOC is detected, both the type of the VOC and the concentration of the gas should be estimated, so that estimation is difficult only with the detected vibration frequency change. In other words, it is possible to obtain the concentration by calculating backward from the expression (8) when the type of the VOC is determined, and it is also possible to estimate the type of the VOC to some extent from frequency change or a calculated K-factor when the concentration is determined. But, for example, for the polymer film of polybutadiene (PBD), the K-factor of ethanol is 269, and the K-factor of dichloromethane is 285, as shown in Table 3, so that this estimation is difficult.

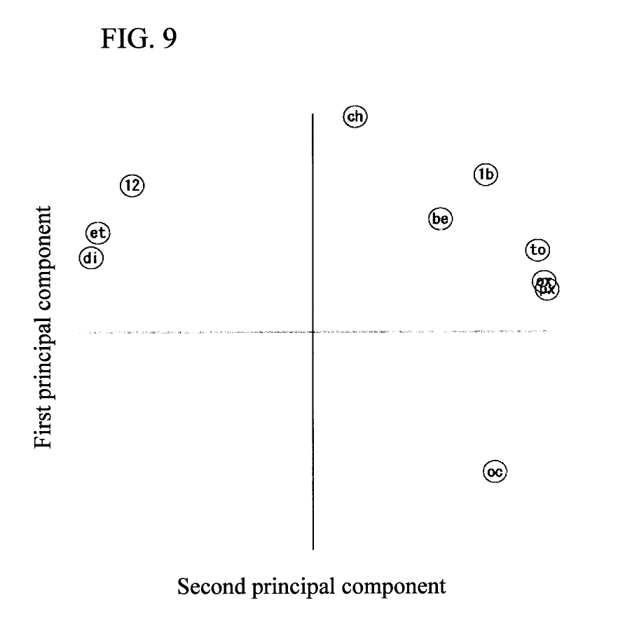

In this case, recognition is possible by principal component analysis. Here, the free software “PPCA1” on the internet was used. The correlation between the first principal component and the second principal component in an example in which principal component analysis was performed with the K-factor in the four polymer films is shown in FIG. 9. In this case, 1,2-dichloroethane (12), ethanol (et), and dichloromethane (di) are positioned in the first quadrant, chloroform (ch), benzene (be), 1-butanol (1b), toluene (to), p-xylene (px), and o-xylene (ox) are positioned in the second quadrant, octane (oc) is positioned in the third quadrant, and they are apart from each other to some extent, so that the recognition of the VOCs can be performed from this diagram.

Particularly, ethanol (et) and 1-butanol (1b), both alcohol, are shown in places quite apart from each other. This seems to be because the tendency of quite opposite magnitude appears for polystyrene and PAB. Also, octane (oc) is independent because the relation of the sensor output of polybutadiene, polyisoprene, and PAB is different from other VOCs. Also, for the distribution of each VOC for the solubility parameter in Table 1, benzene (be), toluene (to), p-xylene (px), and o-xylene (ox) having a benzene ring are positioned in the second quadrant. However, benzene (be) is positioned close to the first quadrant. Also, for 1,2-dichloroethane (12), dichloromethane (di), and chloroform (ch) having a δp of about 5 and a δh of about 5, the first principal component is small. 1,2-dichloroethane (12) and dichloromethane (di) are positioned in the first quadrant, and chloroform (ch) is positioned in the boundary between the first quadrant and the second quadrant.

Here, for the result of the principal component analysis, the contribution rate of the first principal component was 63%, the contribution rate of the second principal component was 30%, and the contribution rate of the third principal component was 7%, meaning that variance is largely determined by the first principal component.

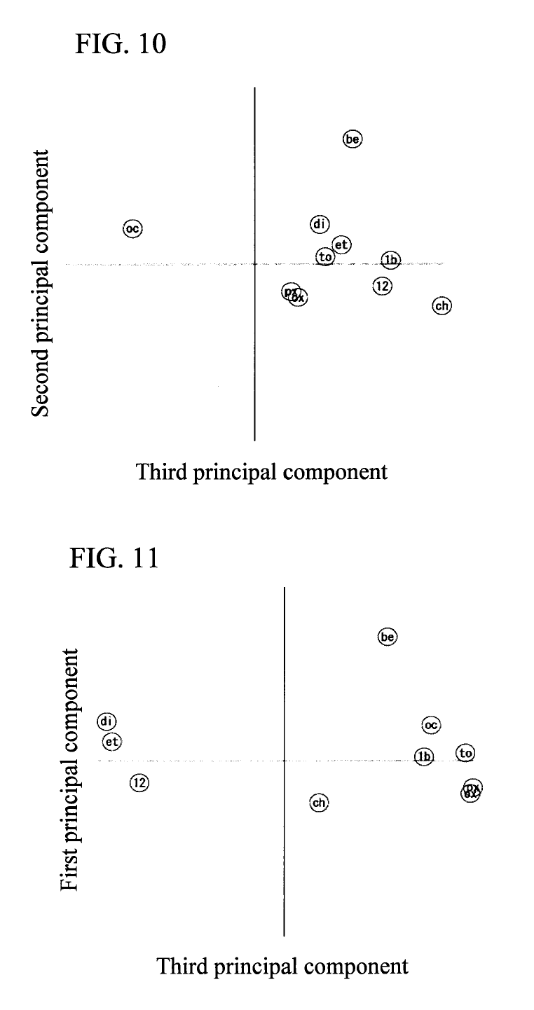

To see the contribution of the third principal component, the correlation between the second principal component and the third principal component is shown in FIG. 10, and the correlation between the first principal component and the third principal component is shown in FIG. 11. What is useful here is that chloroform (ch), benzene (be), and octane (oc) can be clearly separated.

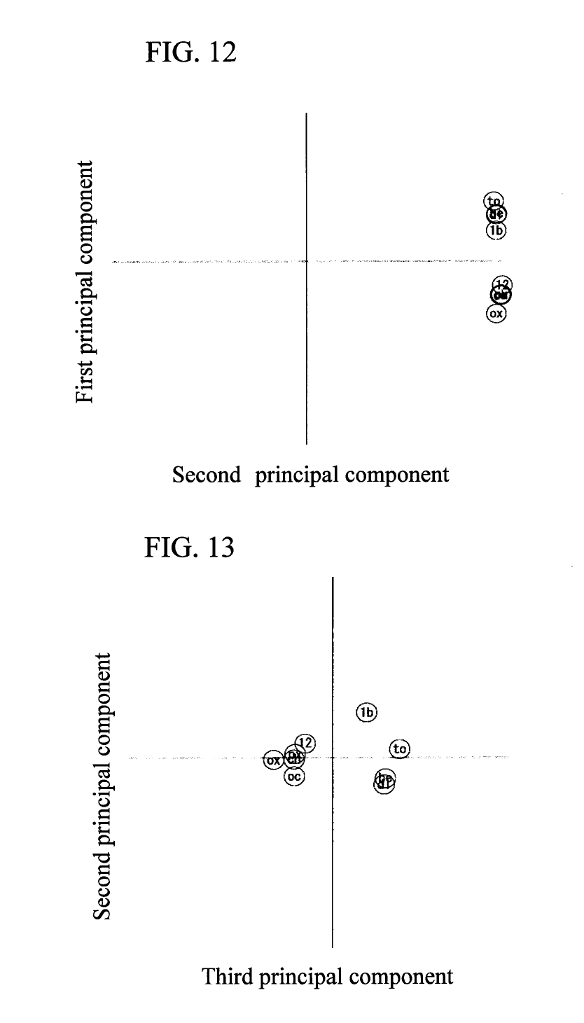

Next, the result of principal component analysis using the adsorption response characteristic τ is shown in FIG. 12. Here, in the principal component analysis using τ, it has been found that the VOCs gather on the right side of the first principal component and cannot be clearly classified. FIG. 8 is one in which the value of each VOC regarding the adsorption response characteristic τ is plotted for each of the four types of polymer films. From FIG. 8, it has been found that there is the same tendency for the four polymer films, meaning that even if a linear combination vector is made with these four and the coefficient is adjusted, all are directed with the same tendency (same direction), so that a large difference does not appear. In other words, there is a clear correlation between a time constant, such as the adsorption response characteristic τ, and the VOC, and for any of the polymer films, octane (oc), benzene (be), toluene (to), p-xylene (px), o-xylene (ox), and 1-butanol (1b) have a long time constant.

The result of the second principal component and the third principal component for the adsorption response characteristic τ is shown in FIG. 13. In FIG. 13, dichloromethane (di) in the first quadrant and benzene (be) and toluene (to) in the second quadrant, which cannot be distinguished by the K-factor, are clearly separated in the third principal component. This shows a possibility that the precision of recognition is further improved by the combination of the K-factor and the time constant.

Here, for the result of the principal component analysis, the contribution rate of the first principal component was 94%, the contribution rate of the second principal component was 5%, and the contribution rate of the third principal component was 1%, meaning that variance is largely determined by the first principal component.

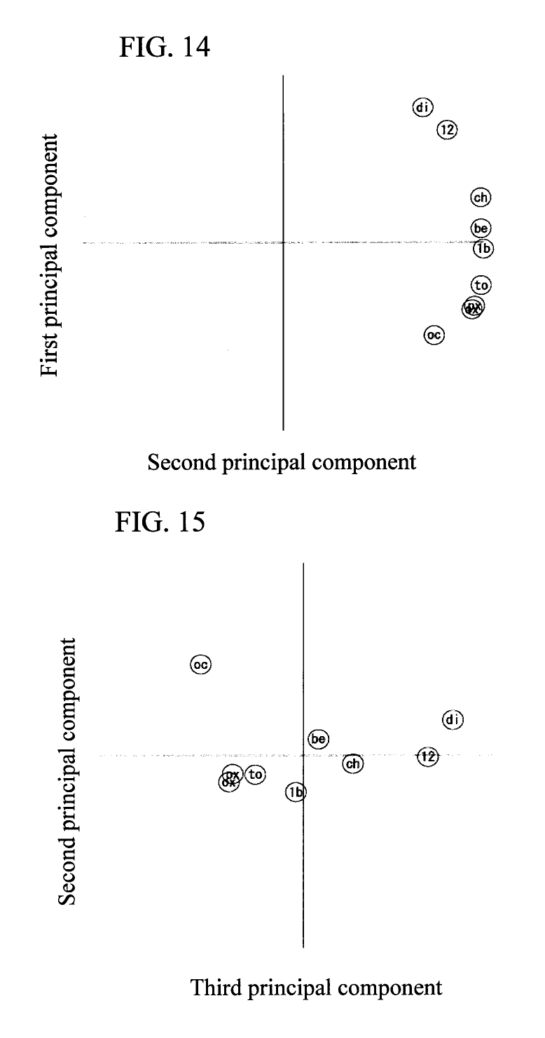

Lastly, the result of performing principal component analysis, using both of the K-factor and the adsorption characteristic τ is shown. The correlation between the first principal component and the second principal component is shown in FIG. 14, and the correlation between the second principal component and the third principal component is shown in FIG. 15. By seeing the variance of the second principal component from these figures, toluene (to), dichloromethane (di), and 1,2-dichloroethane (12) can be easily distinguished.

Here, for the result of the principal component analysis, the contribution rate of the first principal component was 79%, the contribution rate of the second principal component was 16%, and the contribution rate of the third principal component was 5%, meaning that variance is largely determined by the first principal component.

It has been found that by forming these four polymer films in parallel on the quartz resonator type sensor, and measuring its vibration frequency change, or the K-factor converted to concentration, in the above manner, the component and concentration of the VOC can be recognized with some precision, using principal component analysis. The reason is that the patterns of the K-factor of polybutadiene, polyisoprene, polystyrene, and the copolymer having acrylonitrile and butadiene as monomer units for each VOC are different. Also, by adding the data of a time constant, such as adsorption response property, to this, recognition with better precision is possible.

Also, in the sensor of the present invention, multivariate analysis is performed using the adsorption properties as parameters, so that even if a plurality of VOCs are mixed, each VOC can be recognized. Further, also for a VOC whose adsorption property is not previously input, the VOC type can be presumed to some extent by performing multivariate analysis on the adsorption properties of the VOC. Also, in this invention, description has been given using the quartz resonator (QCM), but a frequency detection type mass sensor using a small-size vibrator using a MEMS technique may be used. In this case, integration and integration with a circuit are easy, compared with the QCM.

Also, means that performs molecule recognition using the K-factor that does not depend on the concentration in air and the film thickness of the polymer has been proposed, but when the film thickness of the polymer is fixed, or when the film thickness of the polymer used is previously determined, analysis may be performed using frequency change as it is.

Therefore,it has been accomplished to provide a sensor that can detect various types of VOCs.

### Example 2

In Example 2, the result of studying the recognition of VOCs also including hydrophilic VOCs (alcohol and the like) is shown.

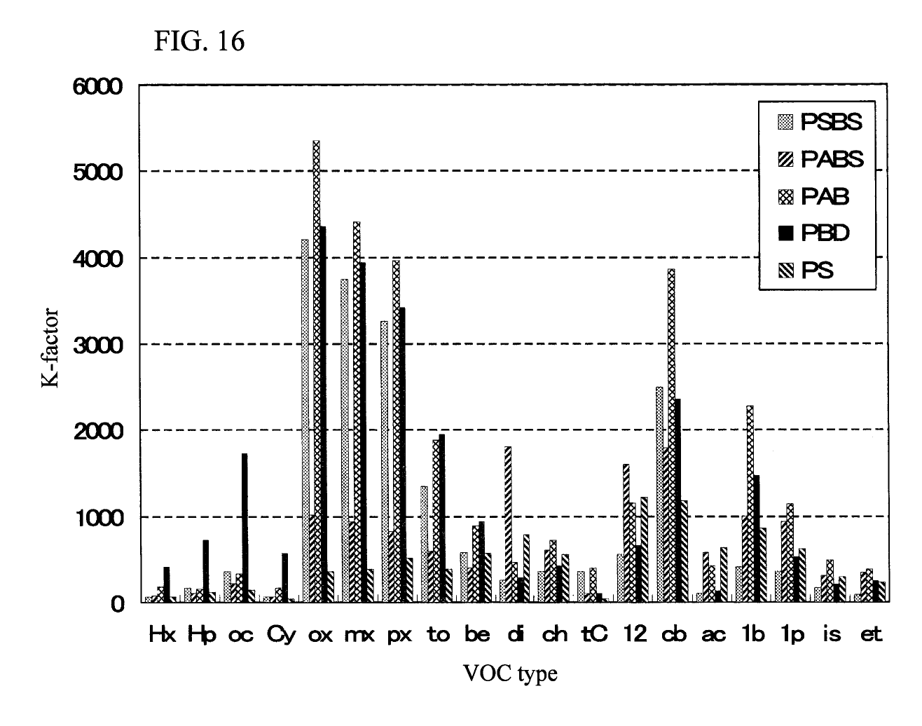

Five types of polymer films of a block copolymer having styrene and butadiene as monomer units (PSBS, styrene content: 30 wt %), a copolymer having acrylonitrile, butadiene, and styrene as monomer units (PABS, acrylonitrile content: 25 wt %), a copolymer having acrylonitrile and butadiene as monomer units (PAB, acrylonitrile content: 37 to 39 wt %), polybutadiene (PBD), and polystyrene (PS) were formed on a sensor element, and the K-factor for 19 types of VOCs was obtained. The results are shown in Table 5 and FIG. 16. The K-factor was calculated from frequency change obtained using the QCM.

The 19 types of VOCs are ethanol (et), 1-propanol (1p), isopropanol (is), 1-butanol (1b), 1,2-dichloroethane (12), dichloromethane (di), chlorobenzene (cb), chloroform (ch), 1,1,1-trichloroethane (tC), benzene (be), toluene (to), o-xylene (ox), m-xylene (mx), p-xylene (px), cyclohexane (Cy), octane (oc), heptane (Hp), hexane (Hx), and acetone (ac). The solubility parameters of these 19 types of VOCs are shown in Table 6. In Table 6, ethanol (et), 1-propanol (1p), isopropanol (is), and 1-butanol (1b) having a large value of the hydrogen bonding component δh are hydrophilic. 1,2-dichloroethane (12), dichloromethane (di), chlorobenzene (cb), chloroform (ch), 1,1,1-trichloroethane (tC), benzene (be), toluene (to), o-xylene (ox), m-xylene (mx), and p-xylene (px) having a large value of the dispersion component δd are hydrophobic.

TABLE 5

| | | | K-factor | | |
|---|---|---|---|---|---|
| VOC | PSBS | PABS | PAB | PBD | PS |
| hexane | 70 | 73 | 184 | 409 | 69 |
| heptane | 169 | 97 | 155 | 714 | 110 |
| octane | 360 | 211 | 332 | 1724 | 138 |
| cyclohexane | 66 | 69 | 164 | 566 | 32 |
| o-xylene | 4198 | 1003 | 5349 | 4353 | 361 |
| m-xylene | 3742 | 930 | 4404 | 3937 | 387 |
| p-xylene | 3250 | 821 | 3956 | 3413 | 516 |
| toluene | 1336 | 588 | 1874 | 1935 | 387 |
| benzene | 573 | 396 | 880 | 933 | 561 |
| dichloromethane | 254 | 1798 | 462 | 285 | 781 |
| chloroform | 361 | 602 | 714 | 419 | 553 |
| 1,1,1-trichloroethane | 363 | 102 | 395 | 101 | 41 |
| 1,2-dichloroethane | 544 | 1596 | 1148 | 655 | 1213 |
| chlorobenzene | 2485 | 1789 | 3855 | 2351 | 1169 |
| acetone | 103 | 575 | 422 | 129 | 623 |
| 1-butanol | 403 | 992 | 2271 | 1474 | 850 |
| 1-propanol | 352 | 930 | 1142 | 526 | 611 |
| isopropanol | 165 | 307 | 491 | 202 | 290 |
| ethanol | 93 | 346 | 381 | 242 | 290 |

TABLE 6

| | δo | δd | δp | δh |
|---|---|---|---|---|
| VOC | (MPa ½) | (MPa ½) | (MPa ½) | (MPa ½) |
| ethanol | 26.5 | 15.8 | 8.8 | 19.4 |
| 1-propanol | 24.5 | 16 | 6.8 | 17.4 |
| isopropanol | 23.5 | 15.8 | 6.1 | 16.4 |
| 1-butanol | 23.1 | 16 | 5.7 | 15.8 |
| 1,2-dichloroethane | 20 | 18.8 | 5.3 | 4.1 |
| dichloromethane | 19.9 | 17.88 | 6.36 | 6.15 |
| chlorobenzene | 19.6 | 19 | 4.3 | 2 |
| chloroform | 19 | 17.8 | 3.1 | 5.7 |
| 1,1,1-trichloroethane | 17.6 | 17 | 4.3 | 2 |
| benzene | 18.6 | 18.4 | 0 | 2 |
| toluene | 18.2 | 18 | 1.4 | 2 |
| o-xylene | 18 | 17.8 | 1 | 3.1 |
| m-xylene | 18 | 17.7 | 1.01 | 3.08 |
| p-xylene | 18 | 17.69 | 1.02 | 3.07 |
| cyclohexane | 16.8 | 16.8 | 0 | 0.2 |
| octane | 15.5 | 15.5 | 0 | 0 |
| heptane | 15.3 | 15.3 | 0 | 0 |
| hexane | 14.9 | 14.9 | 0 | 0 |
| acetone | 20 | 15.5 | 10.4 | 7 |

The result of performing principal component analysis with the K-factor in the five polymer films, using the statistical software “Mikeneko,” is shown in Table 7. In the result of the principal component analysis, the contribution rate of the first principal component was 66%, the contribution rate of the second principal component was 31%, and the cumulative contribution rate of the first principal component and the second principal component was for 97%, as shown in Table 7.

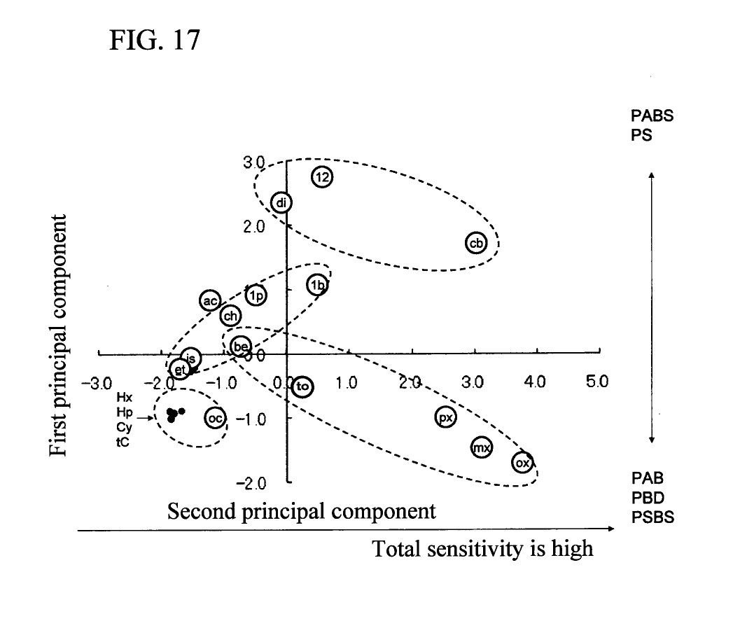

The correlation between the first principal component and the second principal component is shown in FIG. 17. In FIG. 17, acetone (ac), 1-propanol (1p), chloroform (ch), and benzene (be) are positioned in the first quadrant, dichloromethane (di), 1,2-dichloroethane (12), chlorobenzene (cb), and 1-butanol (1b) are positioned in the second quadrant, toluene (to), p-xylene (px), m-xylene (mx), and o-xylene (ox) are positioned in third quadrant, and ethanol (et), isopropanol (is), 1,1,1-trichloroethane (tC), cyclohexane (Cy), octane (oc), heptane (Hp), and hexane (Hx) are positioned in the fourth quadrant. They are apart from each other to some extent, except for 1,1,1-trichloroethane (tC), cyclohexane (Cy), heptane (Hp), and hexane (Hx) in the fourth quadrant, so that the recognition of the VOCs can be performed from this diagram. It is considered that in the result of the principal component analysis shown in FIG. 17, the first principal component shows the total sensitivity of all polymers to the gases, and in the second principal component, gases sensitive to PABS and PS are distributed in +, and gases sensitive to PAB, PSBS, and PBD are distributed in −.

In FIG. 17, when the distribution of each VOC is seen, noting the solubility parameter, it can be confirmed that the VOCs having similar solubility parameter indicators are divided into four groups: a group having hydrophilicity, composed of ethanol (et), 1-propanol (1p), isopropanol (is), and 1-butanol (1b), a group of 1,2-dichloroethane (12), dichloromethane (di), and chlorobenzene (cb) having hydrophobicity, a group of benzene (be), toluene (to), o-xylene (ox), m-xylene (mx), and p-xylene (px), and a group of heptane (Hp), hexane (Hx), cyclohexane (Cy), 1,1,1-trichloroethane (tC), and octane (oc).

TABLE 7

| | principal component (eigenvector) | |
|---|---|---|
| | | second principal |
| | first principal component | component |
| PSBS | 0.5109 | −0.2811 |
| PABS | 0.3708 | 0.5664 |
| PAB | 0.5338 | −0.1624 |
| PBD | 0.4917 | −0.3363 |
| PS | 0.2735 | 0.6787 |
| eigenvalue | 3.291015713 | 1.547266031 |
| contribution rate | 0.658203143 | 0.309453206 |
| cumulative contribution | 0.658203143 | 0.967656349 |
| rate | | |

### Example 3

In Example 3, the result of measuring frequency change with the concentration of two types of VOCs changed, and performing principal component analysis on the measured frequency change to study the recognition of the VOCs is shown. As the VOCs, 200 to 10000 ppm of hydrophilic acetone, and 200 to 2000 ppm of hydrophobic toluene were used. The frequency change was measured by the QCM.

Four types of polymer films of a block copolymer having styrene and butadiene as monomer units (PSBS), a copolymer having acrylonitrile, butadiene, and styrene as monomer units (PABS), a copolymer having acrylonitrile and butadiene as monomer units (PAB), and polystyrene (Ps) were formed on a sensor element, and frequency change for the two types of VOCs having different concentrations was obtained. The frequency change is shown in Table 8.

TABLE 8

| gas/concentration | PSBS | PABS | PAB | PS |
|---|---|---|---|---|
| acetone 200 | 1 | 2 | 1 | 2 |
| acetone 400 | 1 | 4 | 2 | 3 |
| acetone 600 | 1 | 6 | 2 | 4 |
| acetone 800 | 1 | 6 | 2 | 6 |
| acetone 1000 | 1 | 6 | 2 | 7 |
| acetone 2000 | 2 | 8 | 4 | 13 |
| acetone 3000 | 2 | 11 | 5 | 19 |
| acetone 4000 | 3 | 12 | 8 | 23 |
| acetone 5000 | 5 | 14 | 9 | 28 |
| acetone 7000 | 7 | 17 | 15 | 34 |
| acetone 10000 | 10 | 24 | 26 | 44 |
| toluene 200 | 7 | 2 | 9 | 2 |
| toluene 400 | 10 | 3 | 14 | 3 |
| toluene 600 | 17 | 6 | 24 | 4 |
| toluene 800 | 23 | 8 | 32 | 6 |
| toluene 1000 | 24 | 9 | 40 | 10 |
| toluene 2000 | 52 | 17 | 80 | 18 |

The result of performing principal component analysis with the frequency change in the four polymer films shown in Table 8, using the statistical software “Mikeneko,” is shown in Table 9. In the result of the principal component analysis, the contribution rate of the first principal component was for 63%, the contribution rate of the second principal component was for 36.5%, and the cumulative contribution rate of the first principal component and the second principal component was for 99.5%, as seen from Table 9.

TABLE 9

| | principal component (eigenvector) | | | |
|---|---|---|---|---|
| | first principal | second principal | third principal | fourth principal |
| | component | component | component | component |
| PSBS | 0.488462719 | −0.521166786 | 0.166606487 | −0.679729087 |
| PABS | 0.53837521 | 0.423010868 | −0.719889366 | −0.113900134 |
| PAB | 0.53768366 | −0.429838836 | 0.034904125 | 0.724511275 |
| PS | 0.427144726 | 0.603892012 | 0.672891731 | 0.00886227 |
| eigenvalue | 2.519070138 | 1.462230708 | 0.015756773 | 0.002942382 |
| contribution | 0.629767535 | 0.365557677 | 0.003939193 | 0.000735595 |
| rate | | | | |
| cumulative | 0.629767535 | 0.995325211 | 0.999264405 | |
| contribution | | | | |
| rate | | | | |

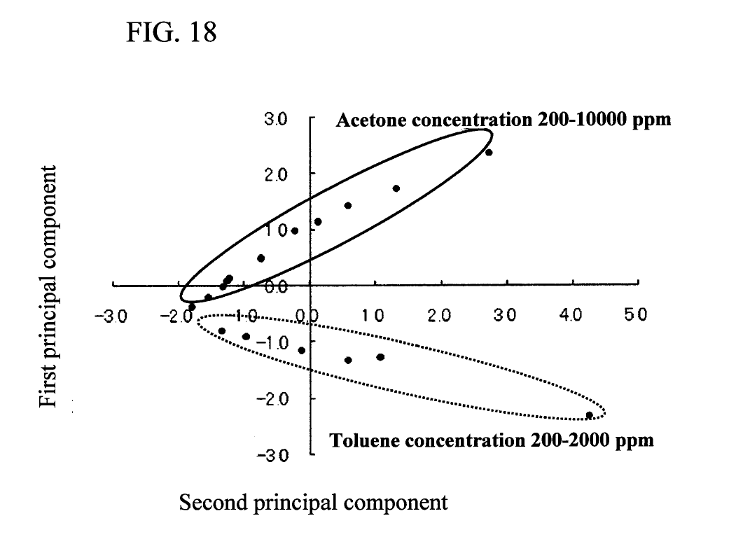

The correlation between the first principal component and the second principal component is shown in FIG. 18. It is considered that in the result of the principal component analysis shown in FIG. 18, the first principal component shows the total sensitivity of all polymers to the gases, and in the second principal component, gases sensitive to PABS and PS are distributed in +, and gases sensitive to PAB and PSBS are distributed in −.

Seeing FIG. 18, acetone and toluene are linearly distributed depending on respective concentrations. When the type of the VOC is determined, the component and concentration of the VOC can be recognized even if principal component analysis is performed using the frequency change as it is.

1. A sensor comprising a sensor element having at least two types or more of polymer films adsorbing a target substance, measurement means that measures adsorption properties of the target substance adsorbed on the polymer films, and recognition means that performs multivariate analysis on the measured adsorption properties to recognize the target substance.

2. The sensor according to claim 1, wherein the adsorption property is at least one or more selected from frequency change, a K-factor, adsorption response property, and desorption property.

3. The sensor according to claim 1, wherein the adsorption property is calculated from frequency change measured using a frequency detection type mass sensor.

4. The sensor according to claim 1, wherein the multivariate analysis is principal component analysis.

5. The sensor according to claim 1, wherein the polymer films are two types or more selected from polybutadiene, polyisoprene, polystyrene, polyacrylonitrile, polycaprolactan, and a copolymer, wherein the copolymer is a copolymer containing two types or more of acrylonitrile, butadiene, styrene, and methyl acrylate, as monomer units.

6. The sensor according to claim 1, wherein the recognition means is recognition means that previously measures adsorption properties of a particular organic compound for the polymer films and that performs multivariate analysis on the previously measured adsorption properties and the adsorption properties of the target substance to recognize the target substance.

7. The sensor according to claim 1, comprising concentration means that previously concentrates a gas to be measured, which contains the target substance, and introduces the concentrated gas into the sensor element.

8. The sensor according to claim 1, wherein a concentration of the target substance in the gas to be measured is measured by the measurement means.
